(19) United States
(12) Patent Application Publication
(10) Pub. No.: US 2023/0151746 A1
(43) Pub. Date: May 18, 2023

(54) CLEANING SYSTEM FOR VEHICLE OIL CIRCUIT

(71) Applicant: NINE CIRCLE TAIWAN CO., LTD., Taichung City (TW)

(72) Inventor: Li-Chu Liu, Taichung City (TW)

(21) Appl. No.: 17/529,631

(22) Filed: Nov. 18, 2021

(51) Int. Cl. F01M 11/03; B01D 35/00; B01D 29/66

(52) U.S. Cl. CPC F01M 11/03; B01D 35/005; B01D 29/66

(57) ABSTRACT

A cleaning system of a vehicle oil circuit is provided, including a filter unit, an oil storage unit and a flushing unit. The filter unit includes a filter chamber, a first oil inlet tube and an oil outlet tube. The first oil inlet tube is communicated with a first opening of the vehicle oil circuit. The oil outlet tube is communicated with a second opening of the vehicle oil circuit. The oil storage unit includes a waste oil chamber and a second oil inlet tube communicated with a third opening of the vehicle oil circuit. The flushing unit includes a flushing chamber and a flushing tube. The flushing chamber receives a washing oil. The flushing tube is communicated respectively with the flushing chamber and a fourth opening of the vehicle oil circuit. The flushing tube guides the washing oil to enter the vehicle oil circuit.

### BACKGROUND OF THE INVENTION

### Field of the Invention

The present invention relates to a cleaning system for a vehicle oil circuit.

### DESCRIPTION OF THE PRIOR ART

Engine oil is used for lubrication, sealing, cooling, cleaning and rust prevention. Specifically, the engine oil may be used to prevent abrasion between adjacent moving parts, form an oil film between surfaces of pistons and cylinders to avoid gas penetration, serve as a cooling agent, remove carbon deposition and oil sludge from the engine, or coat on metal parts to inhibit oxidation.

However, the oil sludge may deposit in the engine (such as the crankcase) and the vehicle oil circuit in long-term use, which may decrease effects of the engine oil, such as cooling, cleaning and lubrication effects, and influence operation of the vehicle.

The present invention is, therefore, arisen to obviate or at least mitigate the above-mentioned disadvantages.

### SUMMARY OF THE INVENTION

The main object of the present invention is to provide a cleaning system for a vehicle oil circuit, which can effectively clean the vehicle oil circuit.

To achieve the above and other objects, the present invention provides a cleaning system for a vehicle oil circuit, including: a filter unit, an oil storage unit and a flushing unit. The filter unit includes a first oil inlet tube, a filter chamber, an oil outlet tube which are communicated with one another and a filter member. The first oil inlet tube is configured to be communicated with a first opening of the vehicle oil circuit, and the oil outlet tube is configured to be communicated with a second opening of the vehicle oil circuit. The first oil inlet tube is configured to guide an oil from the vehicle oil circuit to enter the filter chamber, and the oil outlet tube is configured to guide the oil in the filter chamber to enter the vehicle oil circuit. The filter unit and the vehicle oil circuit form a circulation loop. The filter member is received within the filter chamber and configured to filter the oil. The oil storage unit includes a waste oil chamber and a second oil inlet tube. The second oil inlet tube is configured to be communicated with a third opening of the vehicle oil circuit and guide the oil from the vehicle oil circuit to enter the waste oil chamber. The flushing unit includes a flushing chamber and a flushing tube. The flushing chamber is configured to receive a washing oil, and the flushing tube is communicated respectively with the flushing chamber and a fourth opening of the vehicle oil circuit. The flushing tube is configured to guide the washing oil to enter the vehicle oil circuit.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a drawing showing a flushing unit according to a preferable embodiment of the present invention;

FIG. 3 is a cross sectional view of the flushing unit according to a preferable embodiment of the present invention;

FIG. 4 is a top view of the flushing unit according to a preferable embodiment of the present invention;

FIG. 5 is a side view of an oil storage unit according to a preferable embodiment of the present invention;

FIG. 6 is a cross sectional view of the oil storage unit according to a preferable embodiment of the present invention;

FIG. 7 is drawings showing an arrangement of a heat exchange unit and a filter unit according to a preferable embodiment of the present invention;

FIG. 8 is a stereogram of the heat exchange unit according to a preferable embodiment of the present invention;

FIG. 9 is a breakdown drawing of FIG. 8;

FIG. 10 is a cross sectional view taken along the line A-A of FIG. 8; and

FIG. 11 is a cross sectional view taken along the line B-B of FIG. 8.

### DETAILED DESCRIPTION OF THE PREFERRED EMBODIMENTS

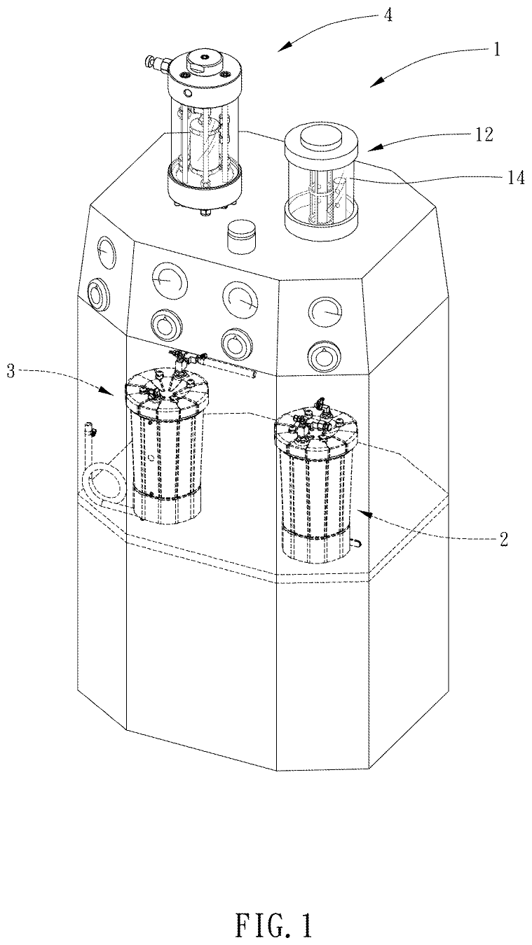

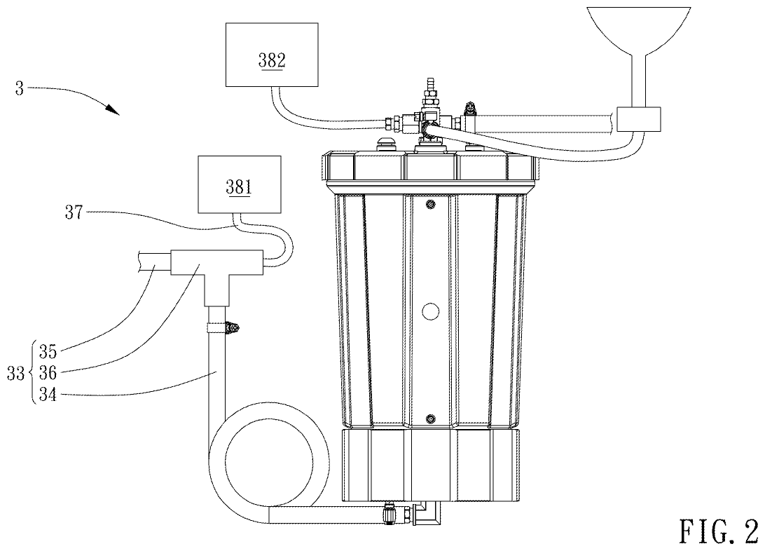

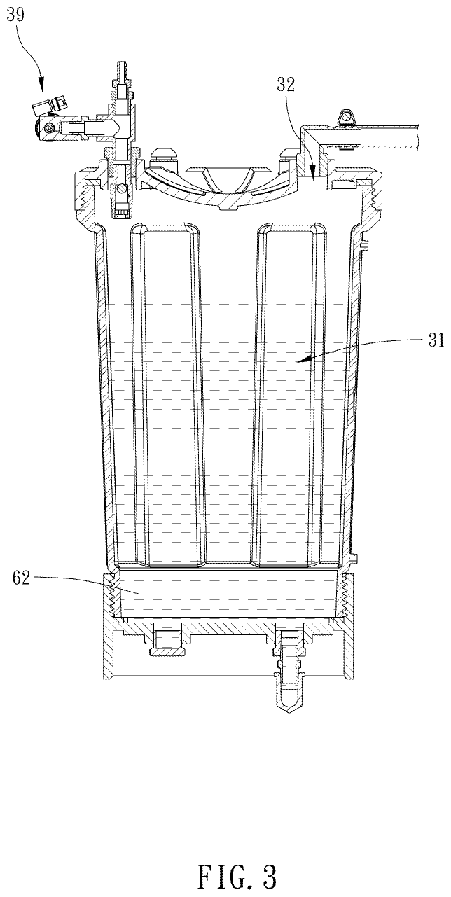

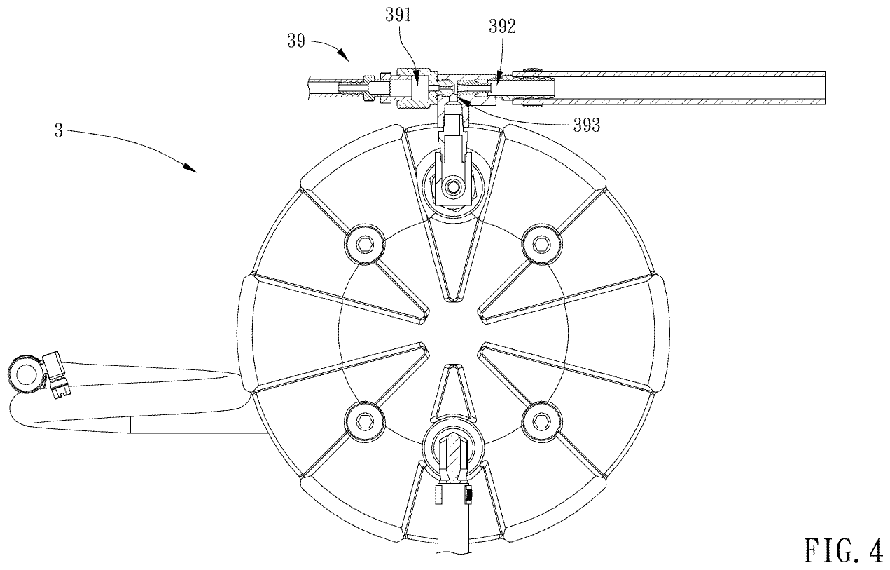

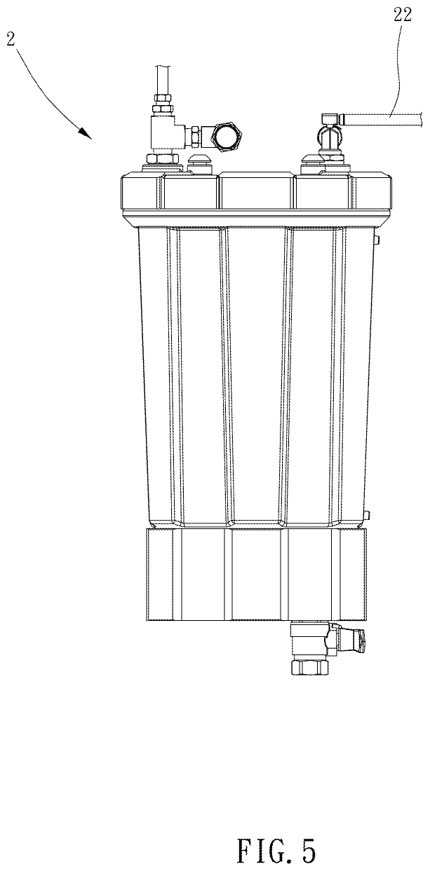

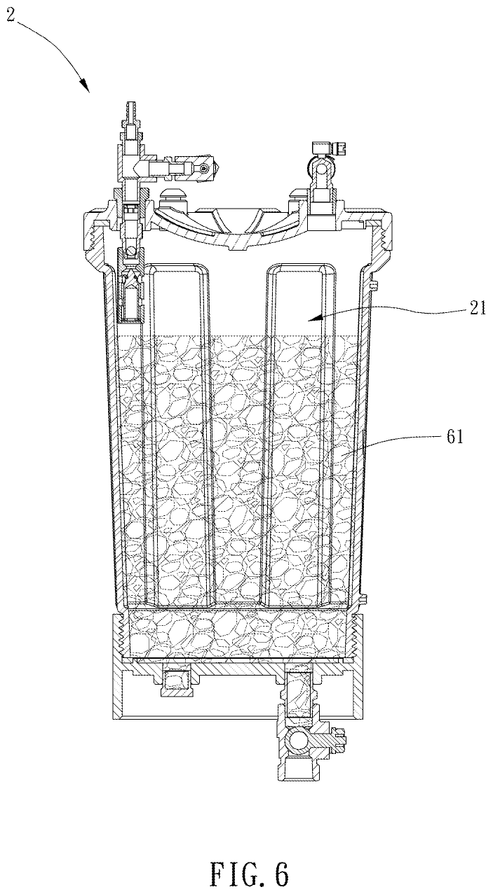

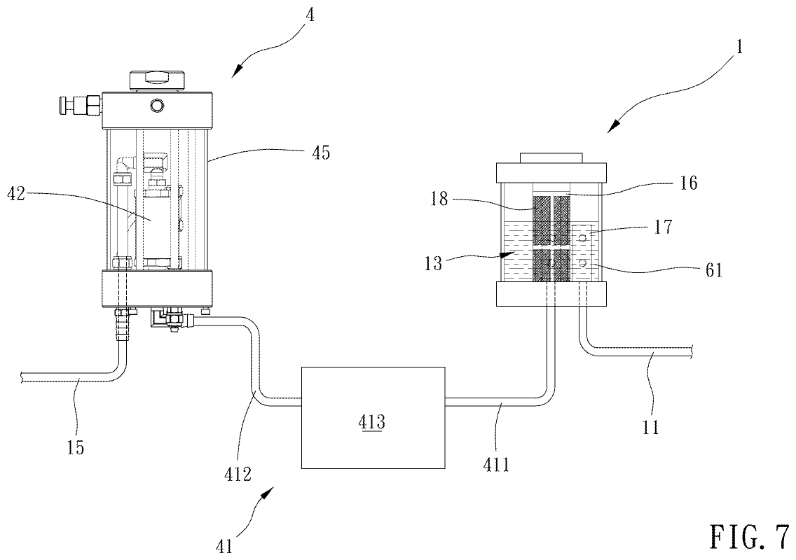

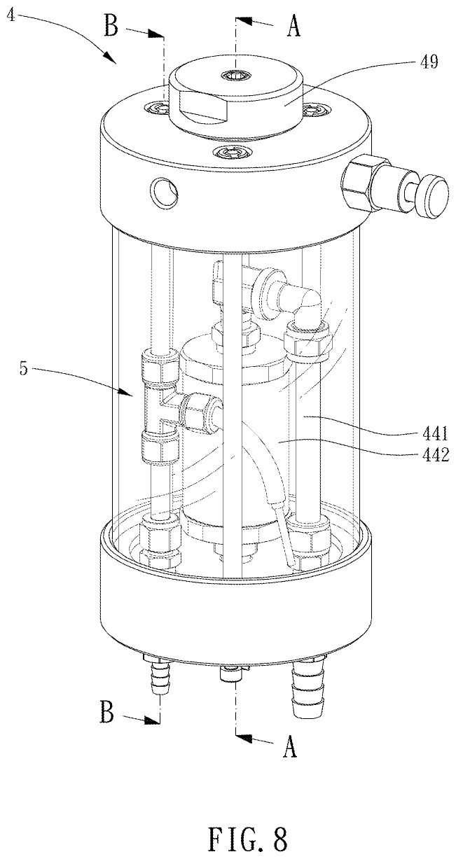

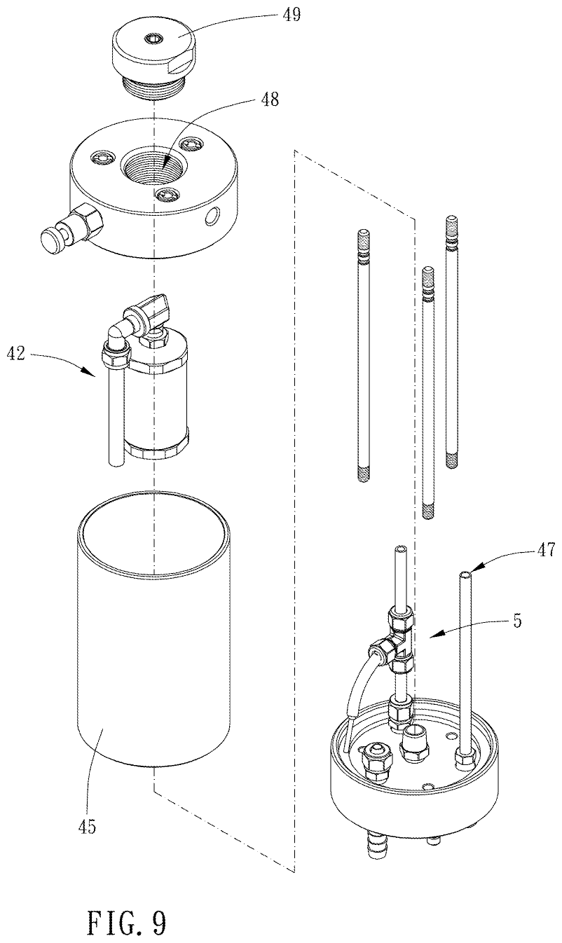

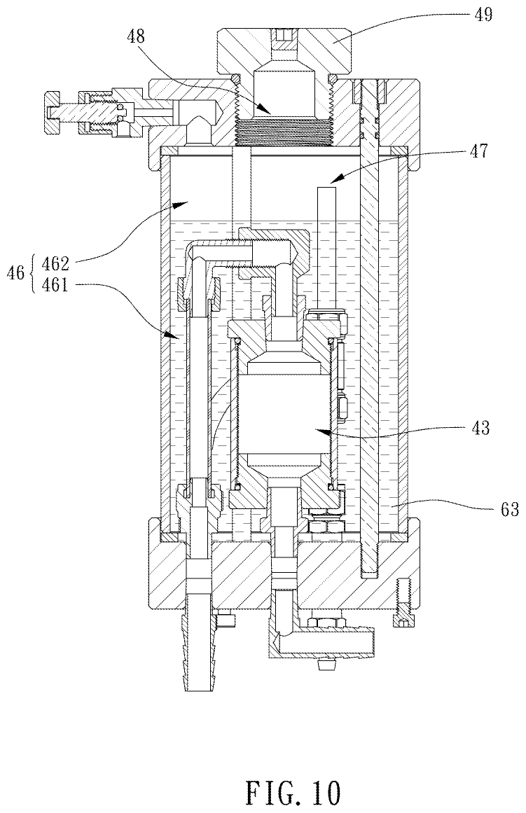

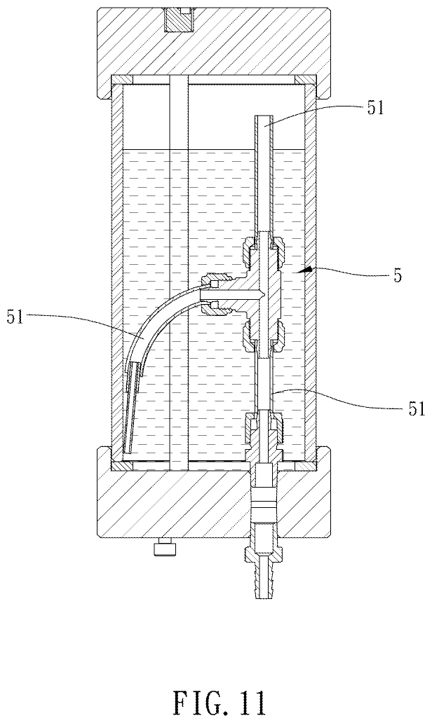

Please refer to FIGS. 1 to 11 for a preferable embodiment of the present invention. A cleaning system for a vehicle oil circuit of the present invention includes a filter unit 1, an oil storage unit 2 and a flushing unit 3.

The filter unit 1 includes a first oil inlet tube 11, a filter chamber 13 and an oil outlet tube 15 which are communicated with one another and a filter member 16. The first oil inlet tube 11 is configured to be communicated with a first opening (such as an insertion hole of an oil level gauge) of the vehicle oil circuit, and the oil outlet tube 15 is configured to be communicated with a second opening (such as an inlet of an engine oil) of the vehicle oil circuit. The first oil inlet tube 11 is configured to guide an oil 61 from the vehicle oil circuit to enter the filter chamber 13, and the oil outlet tube 15 is configured to guide the oil 61 in the filter chamber 13 to enter the vehicle oil circuit. Therefore, the filter unit 1 and the vehicle oil circuit form a circulation loop. The filter member 16 is received within the filter chamber 13 and configured to filter the oil 61 so that the oil 61 is purified and returned to the vehicle oil circuit to flush impurities and oil sludge out. Therefore, the vehicle oil circuit is effectively cleaned in several cycles.

In this embodiment, the filter unit 1 further includes a first guiding member 17 and a second guiding member 18, and the first guiding member 17 and the second guiding member 18 are disposed within the filter chamber 13 and spaced apart from each other. The first guiding member 17 is communicated with the first oil inlet tube 11 and the filter chamber 13, and the second guiding member 18 is communicated with the oil outlet tube 15 and the filter chamber 13. The filter member 16 covers an opening of the second guiding member 18 to filter the oil 61 entering the second guiding member 18. Specifically, the filter chamber 13 is defined by a third container 12 which includes a viewable portion 14, which allows an operator to observe the filter chamber 13 through the viewable portion 14 and decide whether to change the filter member 16 or clean the filter chamber 13.

The oil storage unit 2 includes a waste oil chamber 21 and a second oil inlet tube 22, and the second oil inlet tube 22 is configured to be communicated with a third opening (such as the insertion hole of an oil level gauge) of the vehicle oil circuit and guide the oil 61 in the vehicle oil circuit to enter the waste oil chamber 21. In operation, the oil 61 circulating several times in the vehicle oil circuit is guided to and storage in the oil storage unit 2 after flowing through the filter unit 1, which is convenient for subsequent waste oil recycling operations.

The flushing unit 3 includes a flushing chamber 31 and a flushing tube 33. The flushing chamber 31 is configured to receive a washing oil 62, and the flushing tube 33 is communicated respectively with the flushing chamber 31 and a fourth opening (such as an interface of an oil filter) of the vehicle oil circuit. The flushing tube 33 is configured to guide the washing oil 62 to enter and flush the vehicle oil circuit, and the oil sludge stuck on a wall of the vehicle oil circuit may be washed away. Understandably, the washing oil 62 is directly exhausted to the external environment after flush, through an oil pan drain hole, for example.

Preferably, the flushing unit 3 further includes a gas tube 37 and a first gas pump 381, and the flushing tube 33 includes a first tube 34, a second tube 35 and a second communication tube 36. The first tube 34 communicates the flushing chamber 31 with the second communication tube 36, and the gas tube 37 communicates the first gas pump 381 with the second communication tube 36. The second tube 35 communicates the second communication tube 36 with the fourth opening. The gas tube 37, the first tube 34 and the second tube 35 are communicated with one another by the second communication tube 36. The second tube 35 is configured to guide at least one of the washing oil 62 and a gas supplied from the first gas pump 381 to enter the vehicle oil circuit. Therefore, the vehicle oil circuit may be washed with oil or gas alternatively, or be washed with oil and gas at the same time to increase flushing strength or produce interval-flushing effect.

In this embodiment, the flushing unit 3 further includes a second gas pump 382 and a venturi tube 39, and the flushing chamber 31 has an oil inlet 32 configured to be communicated with an external environment. The venturi tube 39 includes a gas inlet portion 391, a gas outlet portion 392 and a branch portion 393. The gas inlet portion 391 is communicated with the second gas pump 382, and the branch portion 393 is communicated with the flushing chamber 31. The gas outlet portion 392 is selectively openable. When the gas outlet portion 392 is closed, a gas supplied from the second gas pump 382 enters the flushing chamber 31 through the branch portion 393 and is configured to drive the washing oil 62 to enter the second communication tube 36 to flush the vehicle oil circuit. When the gas outlet portion 392 is opened, the gas of the second gas pump 382 is discharged into the external environment through the gas outlet portion 392, and a gas in the flushing chamber 31 is indrawn into the branch portion 393. The oil inlet 32 has a negative pressure relative to a pressure of the external environment, which is contributed to draw the washing oil 62 into the flushing chamber 31.

Preferably, the cleaning system for the vehicle oil circuit further includes a heat exchange unit 4, and the heat exchange unit 4 includes a communication channel 41, a first container 42 and a second container 45. At least a portion of the first container 42 is located within an interior of the second container 45. The first container 42 defines a first space 43, the second container 45 and the first container 42 define a second space 46 therebetween, and the first space 43 is non-communicated with the second space 46. The communication channel 41 communicates the second guiding member 18 with the first space 43, and the oil outlet tube 15 is communicated with the first space 43. The first space 43 is configured to receive the oil 61 from the communication channel 41 and guide the oil 61 to the oil outlet tube 15. The second space 46 is configured to receive a detergent 63. When the oil 61 is in the first space 43, a heat of the oil 61 is transferred to the detergent 63 through the first container 42 so that the detergent 63 is warmed and activated by the heat of the oil 61 to provide good decontamination effect.

In this embodiment, the communication channel 41 includes a first communication tube 411, a second communication tube 412 and a pump 413. The first communication tube 411 communicates the second guiding member 18 with the pump 413, and the second communication tube 412 communicates the pump 413 with the first space 43. Moreover, the first container 42 is entirely disposed within the second space 46 so as to increase a contact area of the first container 42 with the detergent 63 and provide good heat exchange efficiency. The first container 42 includes a communication segment 441 and an enlarged segment 442 which are communicated with each other, and a diametrical dimension of the enlarged segment 442 is larger than a diametrical dimension of the communication segment 441. The enlarged segment 442 provides a large space to receive the oil 61 and slow down a flow rate of the oil 61 so as to have sufficient time for heat exchange. The enlarged segment 442 is communicated with the communication channel 41 to receive the oil 61 with a higher temperature, and the communication segment 441 is communicated with the oil outlet tube 15.

Preferably, the diametrical dimension of the enlarged segment 442 is at least twice the diametrical dimension of the communication segment 441 so as to provide a sufficient receiving space and effectively slow down the flow rate of the oil 61.

Moreover, the enlarged segment 442 is made of a material with a thermal conductivity greater than 60 W/m.K for rapid heat transfer and good heat exchange efficiency. The enlarged segment 442 may be made of metal, such as copper, aluminum, iron, or the like.

The cleaning system for the vehicle oil circuit further includes an atomizing unit 5, and the second container 45 includes a gas inlet channel 47. When the second space 46 is partially filled with the detergent 63, a portion of the second space 46 filled with the detergent 63 defines a liquid region 461, and a portion of the second space 46 without the detergent 63 defines a gas region 462. The gas inlet channel 47 is communicated with the gas region 462, and the atomizing unit 5 includes three first communication tubes 51 communicated with one another. One of the three first communication tubes 51 is communicated with the gas region 462, another of the three first communication tubes 51 is communicated with the liquid region 461, and the other of the three first communication tubes 51 is configured to be communicated with an outlet.

For using the detergent 63, a high pressure gas is supplied into the second space 46 through the gas inlet channel 47, and the high pressure gas urges the detergent 63 to flow into the atomizing unit 5. At the same time, a portion of the high pressure gas is supplied into the atomizing unit 5, and the detergent 63 in the atomizing unit 5 is dispersed and atomized by the high pressure gas. Then, the detergent 63 being atomized is discharged from the outlet for cleaning operation.

The second container 45 further includes a liquid inlet 48 and a plug member 49, and the liquid inlet 48 is communicated with the second space 46. The operator can add the detergent 63 into the second space 46 through the liquid inlet 48. Specifically, the plug member 49 is detachably screwed to a peripheral wall defining the liquid inlet 48.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A cleaning system for a vehicle oil circuit, including:
a filter unit, including a first oil inlet tube, a filter chamber and an oil outlet tube which are communicated with one another and a filter member, the first oil inlet tube configured to be communicated with a first opening of the vehicle oil circuit, the oil outlet tube configured to be communicated with a second opening of the vehicle oil circuit, the first oil inlet tube configured to guide an oil from the vehicle oil circuit to enter the filter chamber, the oil outlet tube configured to guide the oil in the filter chamber to enter the vehicle oil circuit, the filter unit and the vehicle oil circuit forming a circulation loop, the filter member being received within the filter chamber and configured to filter the oil;
an oil storage unit, including a waste oil chamber and a second oil inlet tube, the second oil inlet tube configured to be communicated with a third opening of the vehicle oil circuit and guide the oil from the vehicle oil circuit to enter the waste oil chamber; and
a flushing unit, including a flushing chamber and a flushing tube, the flushing chamber configured to receive a washing oil, the flushing tube being communicated respectively with the flushing chamber and a fourth opening of the vehicle oil circuit, the flushing tube configured to guide the washing oil to enter the vehicle oil circuit.

2. The cleaning system for the vehicle oil circuit of claim 1, wherein the filter unit further includes a first guiding member and a second guiding member, the first guiding member and the second guiding member are disposed within the filter chamber and spaced apart from each other, the first guiding member is communicated with the first oil inlet tube and the filter chamber, the second guiding member is communicated with the oil outlet tube and the filter chamber, and the filter member covers an opening of the second guiding member to filter the oil entering the second guiding member.

3. The cleaning system for the vehicle oil circuit of claim 2, further including a heat exchange unit, wherein the heat exchange unit includes a communication channel, a first container and a second container, at least a portion of the first container is located within an interior of the second container, the first container defines a first space, the second container and the first container define a second space therebetween, the first space is non-communicated with the second space, the communication channel communicates the second guiding member with the first space, the oil outlet tube is communicated with the first space; the first space is configured to receive the oil from the communication channel and guide the oil to the oil outlet tube, the second space is configured to receive a detergent, and a heat of the oil is transferred to the detergent through the first container when the oil is in the first space.

4. The cleaning system for the vehicle oil circuit of claim 3, wherein the first container includes a communication segment and an enlarged segment which are communicated with each other, and a diametrical dimension of the enlarged segment is larger than a diametrical dimension of the communication segment.

5. The cleaning system for the vehicle oil circuit of claim 4, wherein the enlarged segment is made of a material with a thermal conductivity greater than 60 W/m.K.

6. The cleaning system for the vehicle oil circuit of claim 3, further including an atomizing unit, wherein the second container includes a gas inlet channel; when the second space is partially filled with the detergent, a portion of the second space filled with the detergent defines a liquid region, a portion of the second space without the detergent defines a gas region, the gas inlet channel is communicated with the gas region, the atomizing unit includes three first communication tubes communicated with one another, one of the three first communication tubes is communicated with the gas region, another of the three first communication tubes is communicated with the liquid region, and the other of the three first communication tubes is configured to be communicated with an outlet.

7. The cleaning system for the vehicle oil circuit of claim 3, wherein the communication channel includes a first guiding tube, a second guiding tube and a pump, the first guiding tube communicates the second guiding member with the pump, and the second guiding tube communicates the pump with the first space.

8. The cleaning system for the vehicle oil circuit of claim 1, wherein the flushing unit further includes a gas tube and a first gas pump, the flushing tube includes a first tube, a second tube and a second communication tube, the first tube communicates the flushing chamber with the second communication tube, the gas tube communicates the first gas pump with the second communication tube, the second tube communicates the second communication tube with the fourth opening, the gas tube, the first tube and the second tube are communicated with one another by the second communication tube; and the second tube is configured to guide at least one of the washing oil and a gas supplied from the first gas pump to enter the vehicle oil circuit.

9. The cleaning system for the vehicle oil circuit of claim 8, wherein the flushing unit further includes a second gas pump and a venturi tube, the flushing chamber has an oil inlet configured to be communicated with an external environment, the venturi tube includes a gas inlet portion, a gas outlet portion and a branch portion, the gas inlet portion is communicated with the second gas pump, the branch portion is communicated with the flushing chamber, the gas outlet portion is selectively openable; when the gas outlet portion is closed, a gas supplied from the second gas pump enters the flushing chamber through the branch portion and is configured to drive the washing oil to enter the second communication tube to flush the vehicle oil circuit; and when the gas outlet portion is opened, the gas supplied from the second gas pump is discharged into the external environment through the gas outlet portion, and a gas in the flushing chamber is indrawn into the branch portion and the oil inlet has a negative pressure relative to a pressure of the external environment.

10. The cleaning system for the vehicle oil circuit of claim 5, further including an atomizing unit, wherein the second container includes a gas inlet channel; when the second space is partially filled with the detergent, a portion of the second space filled with the detergent defines a liquid region, a portion of the second space without the detergent defines a gas region, the gas inlet channel is communicated with the gas region, the atomizing unit includes three first communication tubes communicated with one another, one of the three first communication tubes is communicated with the gas region, another of the three first communication tubes is communicated with the liquid region, and the other of the three first communication tubes is configured to be communicated with an outlet; the communication channel includes a first guiding tube, a second guiding tube and a pump, the first guiding tube communicates the second guiding member with the pump, and the second guiding tube communicates the pump with the first space; the flushing unit further includes a gas tube and a first gas pump, the flushing tube includes a first tube, a second tube and a second communication tube, the first tube communicates the flushing chamber with the second communication tube, the gas tube communicates the first gas pump with the second communication tube, the second tube communicates the second communication tube with the fourth opening, the gas tube, the first tube and the second tube are communicated with one another by the second communication tube; and the second tube is configured to guide at least one of the washing oil and a gas supplied from the first gas pump to enter the vehicle oil circuit; the flushing unit further includes a second gas pump and a venturi tube, the flushing chamber has an oil inlet configured to be communicated with an external environment, the venturi tube includes a gas inlet portion, a gas outlet portion and a branch portion, the gas inlet portion is communicated with the second gas pump, the branch portion is communicated with the flushing chamber, the gas outlet portion is selectively openable; when the gas outlet portion is closed, a gas supplied from the second gas pump enter the flushing chamber through the branch portion and is configured to drive the washing oil to enter the second communication tube to flush the vehicle oil circuit; and when the gas outlet portion is opened, the gas supplied from the second gas pump is discharged into the external environment through the gas outlet portion, a gas in the flushing chamber is indrawn into the branch portion and the oil inlet has a negative pressure relative to a pressure of the external environment; the enlarged segment is made of metal; the first container is entirely disposed in the second space; the filter chamber is defined by a third container which includes a viewable portion; the diametrical dimension of the enlarged segment is at least twice the diametrical dimension of the communication segment; the second container further includes a liquid inlet and a plug member, the liquid inlet is communicated with the second space, the plug member is detachably screwed to a peripheral wall defining the liquid inlet; and the enlarged segment is communicated with the communication channel, and the communication segment is communicated with the oil outlet tube.
